(19) United States
(12) Patent Application Publication
(10) Pub. No.: US 2007/0265362 A1
(43) Pub. Date: Nov. 15, 2007

(54) Toughened Phenolic Foam

(76) Inventor: Vincent Coppock, Bunbury (GB)

Correspondence Address: JACOBSON HOLMAN PLLC, 400 SEVENTH STREET N.W., SUITE 600, WASHINGTON, DC, 20004, US

(21) Appl. No.: 11/792,709

(22) PCT Filed: Dec. 22, 2005
(86) PCT No.: PCT/IE05/00147

§ 371 Date: Jun. 11, 2007

(30) Foreign Application Priority Data
Dec. 16, 2004 (DE) 10 2004 061 128.9

(51) Int. Cl. C08J 9/14

(52) U.S. Cl. 521/90; 521/180

(57) ABSTRACT

A phenolic closed-cell foam includes polyvinyl pyrrolidone with a molecular weight of from 5,000 to 80,000 as a toughening agent. The polyvinyl pyrrolidone is present in the mixture (excluding blowing agent) in an amount of from 4% to 20% by weight. The foam cells are substantially free of holes or surface defects. The foam has superior fire performance.

The invention relates to phenolic resins.

Historically, phenolic resins have been the preferred thermosetting plastic material when low smoke emission and self-extinguishing ability are of paramount importance in a fire situation. One such application is in building and pipe insulation where phenolic foams provide both thermal insulation and fire resistance.

Presently, in phenolic cellular foam manufacture, a phenolic resole resin is commonly catalysed by either a strong organic or inorganic acid. For example, EP 0 170 357A describes a process for the production of an acid cured phenolic resin foam. The selection of acid type is dependent on the desired curing time and temperature. Cellular insulation foam is produced when the blowing agent that has been blended into the resin starts to boil. Halocarbons and hydrocarbons are commonly used blowing agents. Expansion typically occurs in the temperature range 20° C. to 80° C. Care needs to be taken in the manufacture of phenolic foam to ensure that an excessive resin exotherm does not develop. The occurrence of an uncontrolled exothermic chemical reaction is more likely when a strong acid is used as catalyst. When exothermic reactions develop, large amounts of water or steam are created by the phenolic resin condensation polymerisation reaction. This adversely affects the ability to form closed cell foam. Closed cell foam structure is highly desirable to maximise insulation performance. By selection of the type and amount of phenolic resin, acid catalyst, surfactant and blowing agent, and then mixing these ingredients and curing at elevated temperature, it is possible to produce phenolic foam that has closed cell structure.

Electron microscopy can be used to demonstrate whether foam cells have defects such as holes or cracks. It is desirable to have low density, defect free, closed cell foam for low cost, stable thermal insulation. Defects in cells can lead to a loss of chemical blowing agent from the cells and air diffusing into the cells raising thermal conductivity. This is undesirable for an insulation material.

In a fire situation, when phenolic foam thermally degrades, there is only low smoke evolution and a high char yield remains. An inherent problem with phenolic foam is the brittleness of the foam. In a fire, closed cell phenolic foam often violently breaks up into chips or fragments. This phenomenon is known as spalling. Spalling can adversely affect the fire integrity and insulation performance of closed cell phenolic foam. In a fire, open cell phenolic foam shows much reduced spalling but it is an inferior insulation material compared to closed cell foam.

Thus, there is a need to provide a low density closed cell phenolic foam without holes or cracks in the cells. Further, there is a need for a phenolic resin system that can be easily mixed at room temperature and does not require excessive use of diluents such as phenol, water or glycols to lower viscosity. In addition, it is desirable that low density closed cell phenolic foam does not spall in a fire, thereby improving the fire resistance of the phenolic foam. Ideally the phenolic foam should have better fire integrity and fire insulation performance in a standard resistance to fire test such as BS476 Part 22.

Phenolic foam can be prepared in blocks, laminated boards or as moulded sections of a particular shape. In one industrial process, laminated phenolic foam insulation boards are manufactured with typical thickness 20-110 mm and a dry density of 30-50 kg/m3. In this process, phenolic resin, acid, and blowing agent are mixed using a conventional peg mixer head. The catalysed liquid resin is then introduced into a foam laminating machine in between aluminium foil, steel plates or glass mat facings. Foaming commences. These foam insulation boards are typically produced at 70° C. in about 3 to 20 minutes. The foam boards then require an oven postcure at 50 to 90° C. for 6 to 72 hours to develop sufficient handling strength. The resin system typically comprises the following generic chemical ingredients listed with typical weight proportions parts by weight (pbw):

Liquid phenolic resole resin (typically 65-85% cured solids) containing 1 to 10% surfactant: 100 pbw

Blowing agent (typically halocarbon or hydrocarbon based): 5-20 pbw

Strong organic or mineral acid 9-25 pbw

When phenolic foam panels are first manufactured, thermal conductivity (λ value) at 23° C. is typically 0.018-0.025 W/m.K depending on the blowing agent selected. Such low thermal conductivity values indicate a closed cellular structure, which retains the blowing agent if there are no cell defects. Cell size is typically 30-200 μm. For effective insulation, laminated foam panels are required to have low thermal conductivity stability (λ value) for a long time. To prove long-term low thermal conductivity stability at room temperature, samples of foam panels can be thermally aged at 70° C. for an extended time period following the procedures in European Standard EN 13166. If λ value is low and stable after such accelerated thermal ageing, confidence exists for assuming that the insulation panels will provide long-term low thermal conductivity in service.

In the manufacture of acid cured phenolic foam, the manufacturing conditions used must be carefully controlled if a closed cell structure is to be achieved. If stringent procedures are not followed, initial λ values can be as high as 0.035 W/m.K for 25 to 60 kg/m3 density foam, indicating loss of closed cell integrity and ingress of air into the cells. The type and amount of catalyst used in phenolic foam manufacture has a profound effect on the long-term stability of the foam cells. Increased catalyst levels tend to result in foam with poor initial λ values, or foam in which λ values increases with time.

Phenolic resins are cured by condensation polymerisation at ambient or warm temperature in the presence of acid catalysts. Cured phenol formaldehyde polymers are known for being very brittle materials. In a diverse range of applications, to improve toughness, phenolic resins are often modified by elastomers or thermoplastics. The thermoplastics may be pre-dissolved in the phenolic resin at elevated temperature or may be pre-dissolved in a solvent or diluent and then introduced into the phenolic resin. Examples of some of the commonly used toughening agents for phenolic resins are polyvinyl formal, polyvinyl butyral, polyvinyl alcohol, special grades of polyamide, and nitrile rubber. However, when such toughening agents are used to modify phenolic resin in the manufacture of phenolic foam, open cell foam results. Such open cell foam has much inferior insulation performance and can suffer from moisture ingression, further increasing foam density and thermal conductivity.

### STATEMENTS OF INVENTION

According to the invention there is provided a closed cell foam that includes a thermoplastic or elastomeric toughening agent. In a particularly preferred embodiment of the invention the thermoplastic toughening agent is low molecular weight polyvinyl pyrrolidone. The weight average molecular weight range of the polyvinylpyrrolidone (PVP) is from 5,000 to 80,000, preferably from 6,000 to 15,000.

In a preferred embodiment, the foam is formed from a resin mixture and the toughening agent is present in the mixture (excluding blowing agent) in an amount of from 4% to 15%, typically 6% to 10% by weight.

In another aspect, the invention provides a resin mixture for forming a cellular plastic foam, the resin mixture including an elastomer or toughening agent as defined above.

In the present invention, low density, closed cell phenolic foam, free of holes and cracks in the cells, is made by mixing phenolic resin containing surfactant, catalyst and blowing agent at room temperature. The low resin viscosity necessary for efficient mixing of acid catalyst and blowing agent into the phenolic resin is achieved by maintaining water content in the resin system above 12%.

Surprisingly, it has been found that phenolic resins modified by the addition of low molecular weight polyvinyl pyrrolidone can be used to produce closed cell phenolic foam. This polyvinyl pyrrolidone modified phenolic foam does not show any holes in the cells when examined by electron microscopy. This is the case even when the water content of the phenolic resin is above 12%. At such water content levels, cellular defects such as pin holes would normally be expected. The presence of defects in cells has a profound effect on thermal conductivity.

In particular, the invention provides an improved phenolic foam cellular structure to maintain insulation performance without the need of having water content in the resin below 12%. If water content is below 12%, mixing of the resin, blowing agent and acid catalyst becomes difficult at room temperature due to high resin viscosity. It has been surprisingly found that the addition of a limited amount of low molecular weight polyvinyl pyrrolidone (PVP) to the phenolic resin system permits largely defect free foam cells to be produced even when foam density is 25 to 351 kg/m³. No other changes to the formulation are required. The foams produced are substantially rigid and are unlikely to distort.

A solution has been discovered to the problem of spalling of phenolic foam in a fire situation thereby improving the fire resistance of the insulation board in application. It has also been found that low molecular weight polyvinyl pyrrolidone modified phenolic foam shows a much reduced tendency to spall in a fire. This reduction in spalling is highly desirable for building insulation applications.

It is believed that polyvinyl pyrrolidone acts as a soluble toughening agent for phenolic resin. Due to the inherent water solubility of PVP, water that is present in the phenolic resin as supplied and water that is produced by the phenolic condensation polymerisation reaction will be retained within the cured foam cell walls. Such water does not separate out from the cured cell walls thus avoiding holes and defects in the cells.

### BRIEF DESCRIPTION OF THE FIGURES

The invention will be more clearly understood from the following description thereof given by way of example only with reference to the Figures, in which:

FIG. 1 is a photomicrograph of a phenolic foam sample manufactured with the resin having a water content of 18 to 20% described in Comparative Example A

FIG. 2 is a photomicrograph of a phenolic foam sample manufactured with the formulated resin having a water content of 11.9% described in Comparative Example B

FIG. 3a is a photomicrograph of a phenolic foam sample manufactured with a resin having a water content of 10% and containing polyvinyl pyrrolidone grade K15 described in Example 1.

FIG. 3b is another view of the foam sample of Example 1.

FIG. 4 is a photomicrograph of a phenolic foam sample manufactured with a resin having a water content of 14.1% and containing polyvinyl pyrrolidone Grade K15 described in Example 2.

### DETAILED DESCRIPTION

Polyvinyl pyrrolidone, (PVP) is commercially available; one supplier is International Scientific Corp. It is offered in a variety of grades of differing molecular weight. The supplier defines average molecular weights for the grades available in the range 9,700 to 3,470,000. (Average molecular weight determined by Gel Permeation Chromatography with Multi Angle Laser Light Scattering detector) For the purpose of this invention, low molecular weight levels in the range 6,000 to 80,000 are preferred. This corresponds to commercial Grades PVP K15 & PVP K30. More preferred is Grade PVP K15.

Electron microscopy has been used to examine the cell structure of phenolic foam samples. Foam samples are spray gold coated as an aid to see cellular defects more clearly. The phenolic foam samples examined by electron microscopy contained different water contents. There were phenolic foam samples both with and without polyvinyl pyrrolidone modification for examination.

Synthesis of Phenolic Resole Resin A

Resin A has a Phenol Formaldehyde molar ratio of 1:1.60. To a 3 litre glass split reactor flask fitted with a reflux condenser and motorised stirrer was added, 1000 g of phenol and 21 parts of 50% potassium hydroxide with agitation. The pH is in the range 8.5 to 9.5.

Next, 1021 g of 50% formaldehyde solution (formalin) are slowly added at a controlled rate to ensure an excessive exotherm does not occur and temperature remains between 78 to 80° C. The resin is held at 80° C. for 90 minutes and distilled to give a % water content of 20-22% as determined by Karl Fisher water analysis technique. The resin is cooled down. Diethylene glycol is added to give a concentration of 3 to 5% by weight. Then this is followed by ethoxylated castor oil surfactant containing 20-40 moles of ethylene oxide per mole of castor oil, to give a concentration of 4 to 6% by weight. The resin has a final water content of 18-20%. This resin is designated as Resin A.

Phenolic Resole Resin B

Resin B is a commercially available Phenol Formaldehyde resin supplied by Sumitomo Bakelite Europe Group under the trade name R329. The resin has a final water content of 13.1-14.9%.

Synthesis of Phenolic Resole Resin C

Resin C is a Phenol Formaldehyde resin supplied by Sumitomo Bakelite Europe Group under the trade name DER287. Resin C is the same chemical composition as Resin B but it has further reduced water content. The resin has a final water content of 11.3-12.8%.

### COMPARATIVE EXAMPLE A

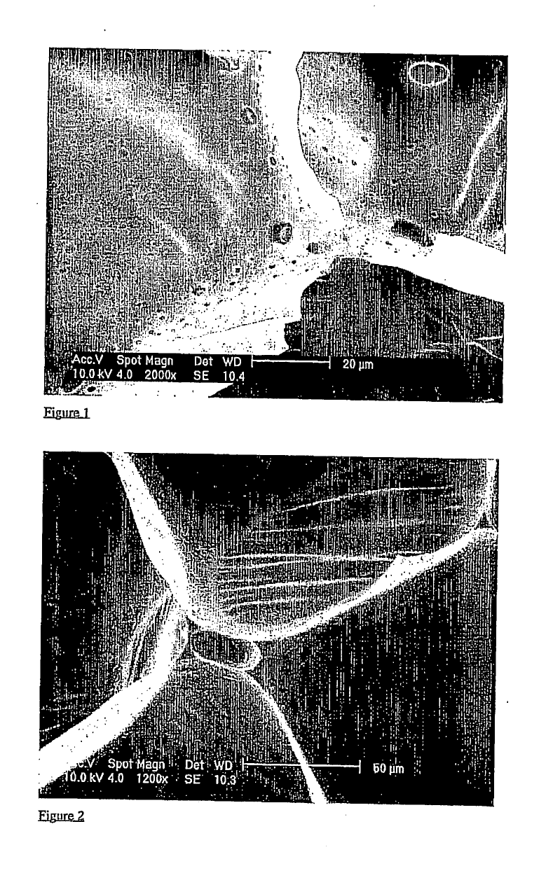

The following example shows how the foam sample shown in FIG. 1 was prepared.

No polyvinyl pyrrolidone is present and the formulated phenolic resin has relatively high water content, (18-20%)

To 125 g of Resin A at 20° C. is added 6.75 g of pre-blended cyclopentane/isopentane (85/15 by weight) and 0.75 g of PF5050 perfluoroalkane from 3M as a blowing agent blend at 5° C. Finally, 20 g of 65% solution of phenol sulphonic acid, E398, (from Clariant UK plc), held at 14° C., was rapidly added to the formulated resin whilst being stirred at 1000-3000 rpm.

Mixing takes<10 seconds and the resin mixture was quickly poured into a 30×30×2.5 cm picture frame mould preheated to 70° C.

A pressure of 12 KPa was applied to the mould to apply light pressure to the rising foam. Then the mould was quickly transferred to an oven for curing at 70° C. for 30 minutes. The foam sample was post-cured for 24 hours at 70° C. The foam board produced had a cured density of 43.5 kg/m3.

FIG. 1 shows an electron micrograph of a sample of the phenolic foam from Comparative Example 1 with a magnification of 2000. Holes are clearly visible in the foam cells.

### COMPARATIVE EXAMPLE B

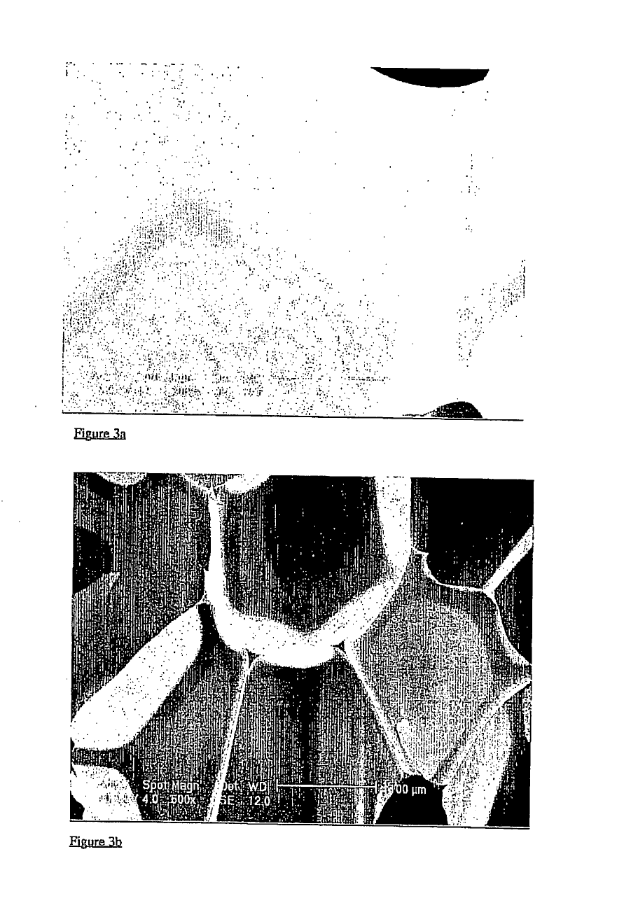

The following example shows how the foam sample shown in FIG. 2 was prepared.

No polyvinyl pyrrolidone is present.

To 79.4 g of Resin C Phenolic resin, (water content 12.4% by weight), was added 3.16 g of micronised urea at 17° C. and mixed into the resin for several minutes. The resin blend was allowed to stand for 1 hour. Then 12.8 g of pre-blended isopropyl chloride/isopentane (85/15 by weight) blowing agent at 5° C. was mixed into the resin. Finally, 14.1 g of liquid para-toluene sulphonic acid/xylene sulphonic acid blend (65/35 w/w) at 92% concentration, (from Degussa UK plc) at 14° C., was rapidly added to the formulated resin whilst being stirred at 1000-3000 rpm.

Mixing takes<10 seconds and the resin mix is quickly poured into a 30×30×2.5 cm picture frame mould preheated to 70° C.

A pressure of 40 KPa was applied to the mould to apply pressure to the rising foam.

Then the mould was quickly transferred to an oven for curing at 70° C. for 15 minutes. The foam sample was then post-cured for 12 hours at 70° C. The foam board produced had a dry cured density of 28.8 kg/m3.

FIG. 2 shows an electron micrograph of a sample of the phenolic foam from Comparative Example B with a magnification of 1200. Holes are not visible but surface blemishes and minor cracks are visible.

### EXAMPLE 1

The following example demonstrates how the foam shown in FIGS. 3a and 3b was prepared.

Here, polyvinyl pyrrolidone is present in the phenolic resin. The resin system has a water content of 10% including additives but excluding acid and blowing agent.

PVP Grade K15 thermoplastic is pre-dissolved in ethylene glycol in 1:1 weight proportions at 70° C. and allowed to cool to 20° C.

Then, 12.37 g of PVP K15/ethylene glycol solution was added to 67 g of Resin C (water content 12.4% by weight), and mixed until homogeneous. 3.16 g of micronised urea was added to this resin and mixed into the resin at 17° C. The resin mix was allowed to stand for 1 hour. Then 7.3 g of pre-blended cyclopentane/isopentane (85/15 by weight) with 0.8 g of PF5050 perfluoroalkane as blowing agent mixture at 5° C. was pre-mixed into the resin. With the resin temperature at 16.8° C., 13.69 g of liquid para toluene sulphonic acid/xylene sulphonic acid blend (65/35 w/w) at 92% concentration from Degussa (UK) plc at 14° C., was rapidly added to the formulated resin whilst being stirred at 1000-3000 rpm.

Mixing takes<10 seconds and the resin mix is quickly poured into a 30×30×2.5 cm picture frame mould preheated to 70° C.

A pressure of 1.3 KPa was applied to the mould to apply light pressure to the rising foam. Then the mould is quickly transferred to an oven for curing at 70° C. for 15 minutes. The foam sample was post-cured for 18 hours at 70° C. The foam board produced had a cured density of 27.4 kg/m3.

FIG. 3a shows an electron micrograph of a sample of die phenolic foam with a magnification of 1200. Cells are largely free from holes, blemishes and ripples.

FIG. 3b is another view of the foam samples shown in FIG. 3a but with a magnification of 500. Cells are largely free from holes, blemishes and ripples.

### EXAMPLE 2

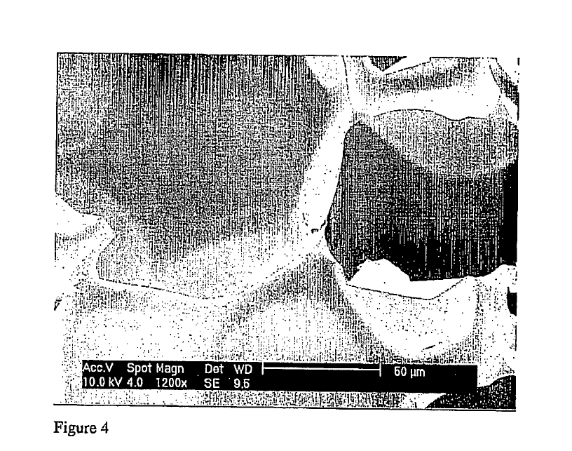

The following example shows how the foam shown in FIG. 4 was prepared.

Polyvinyl pyrrolidone is present in the foam. The resin system including additives, urea, polyvinyl pyrrolidone and ethylene glycol has an increased water content of 14.1% excluding the addition of acid and blowing agent.

PVP Grade K15 thermoplastic is pre-dissolved in ethylene glycol in 1:1 weight proportions at 70° C. and allowed to cool to 20° C. Then, 12.37 g of PVP K15/ethylene glycol solution was added to 68.1 g of Resin B (water content 13.9% by weight), and mixed until homogeneous. 3.16 g of micronised urea was added to this resin and mixed into the resin at 14° C. This was followed by 2.68 g of water. The resin mix was allowed to stand for 1 hour. Then 6.5 g of pre-blended cyclo-pentane/isopentane (85/15 by weight) with 0.7 g of PF5050 perfluoroalkane as blowing agent mixture at 5° C. was premixed into the resin. Finally, 14.39 g of liquid para toluene sulphonic acid/xylene sulphonic acid blend (65/35 w/w) at 92% concentration from Degussa UK held at 14° C. was rapidly added to the formulated resin whilst being stirred at 1000-3000 rpm.

Mixing takes<10 seconds and the resin mix is quickly poured into a 30×30×2.5 cm picture frame mould preheated to 70° C.

A pressure of 1.3 KPa was applied to the mould to apply light pressure to the rising foam. Then the mould is quickly transferred to an oven for curing at 70° C. for 15 minutes. The foam sample was post-cured for 18 hours at 70° C. The foam board produced had a cured density of 33 kg/m3.

FIG. 4 shows an electron micrograph of a sample of the phenolic foam with a magnification of 1200. Cells are largely free from holes, blemishes and ripples despite a water content of 14.1% excluding blowing agent and acid.

Table 1 below shows the insulation performance of a 25×25×2.5 cm thick sample of phenolic foam prepared in accordance with the procedures of Comparative Example 3 that has been thermally aged at 70° C.

TABLE 1

| | |
|---|---|
| Initial λ value (W/m · K) | 0.0243 |
| λ value after 1 day (W/m · K) | 0.0241 |
| λ value after 43 days (W/m · K) | 0.0234 |
| λ value after 84 days (W/m · K) | 0.0252 |

Minimal change in thermal conductivity occurs. Thus it is apparent that addition of PVP does not hinder closed cell structure stability.

Fire Performance Enhancement

Another useful feature of the invention is improved fire resistance due to reduced spalling in a fire situation.

Samples of foam, 10×10×2.5 cm from Examples A and B were exposed to the full blue flame of a laboratory Bunsen burner for 1 minute. The foams began to spall extensively after only a few seconds.

Samples of foam, 10×10×2.5 cm from Examples 1 and 2 were exposed to the full blue flame of a laboratory Bunsen burner for 1 minute. The foam showed virtually no spalling.

The invention is not limited to the embodiments hereinbefore described, which may be varied in detail.

1-18. (canceled)

19. A phenolic closed-cell foam including a toughening agent.

20. The foam as claimed in claim 19 wherein the toughening agent is a low molecular weight thermoplastic or elastomer that is soluble or miscible in phenolic resin.

21. The foam as claimed in claim 19 wherein the thermoplastic or elastomer is polyvinyl pyrrolidone.

22. The foam as claimed in claim 21 wherein the polyvinyl pyrrolidone has an average molecular weight in the range of from 5,000 to 80,000.

23. The foam as claimed in claim 21 wherein the polyvinyl pyrrolidone has an average molecular weight in the range of from 6,000 to 15,000.

24. The foam as claimed in claim 21 wherein the foam is formed from a phenolic resole resin mixture and the polyvinyl pyrrolidone is present in the mixture (excluding blowing agent) in an amount of from 4% to 20% by weight.

25. The foam as claimed in claim 24 wherein polyvinyl the pyrrolidone is present in the mixture (excluding blowing agent) in an amount of from 6% to 10% by weight.

26. The foam as claimed in claim 20 which is a phenolic closed-cell insulation foam.

27. A resin mixture for forming a cellular plastic phenolic foam, the resin mixture including a toughening agent.

28. The resin mixture as claimed in claim 27 wherein the toughening agent is a low molecular weight thermoplastic or elastomer.

29. The resin mixture as claimed in claim 27 wherein the toughening agent is polyvinyl pyrrolidone.

30. The resin mixture as claimed in claim 29 wherein the polyvinyl pyrrolidone has an average molecular weight of from 5,000 to 80,000.

31. The resin mixture as claimed in claim 30 wherein the polyvinyl pyrrolidone has an average molecular weight in the range of from 6,000 to 15,000.

32. The resin mixture as claimed in claim 27 wherein polyvinyl pyrrolidone is present in the mixture (excluding blowing agent) in an amount of from 4% to 20% by weight.

33. The resin mixture as claimed in claim 27 wherein polyvinyl pyrrolidone is present in the mixture (excluding blowing agent) in an amount of from 6% to 10% by weight.

34. The resin mixture as claimed in claim 27 wherein the water content of the resin mixture is from 7% to 16% by weight.
